(19) United States
(12) Patent Application Publication
(10) Pub. No.: US 2025/0271402 A1
(43) Pub. Date: Aug. 28, 2025

(54) SYSTEMS AND METHODS FOR INSPECTION OF COMPLEX WELD GEOMETRIES

(71) Applicant: SAUDI ARABIAN OIL COMPANY, Dhahran (SA)

(72) Inventors: Hani Ragb Abdulhadi Akl, Dekernes (EG); Abdullah Mohammed Saleh Al Khalifah, Dammam (SA); Yousef Ahmed Ali Al Munif, Saihat (SA); Ahmed A Al-Shammari, Dammam (SA)

(73) Assignee: SAUDI ARABIAN OIL COMPANY, Dhahran (SA)

(21) Appl. No.: 18/589,739

(22) Filed: Feb. 28, 2024

(51) Int. Cl. G01N 29/265; G01N 29/24

(52) U.S. Cl. CPC G01N 29/265; G01N 29/2437; G01N 2291/267

(57) ABSTRACT

Various methods, systems, and devices for investigating welds are discussed. As an example, a method for investigating welds is discussed that includes: automatically configuring, by a controller, a plurality of acoustic sensors arranged across a face of a phased array device to sense reflected acoustic signals; automatically configuring, by the controller, acoustic sources arranged across the face of the phased array device emit sent acoustic signals across an angular range from 40 degrees to 70 relative to the face; moving the phased array device across a surface of an examined article comprising a weld, where the face moves parallel to the surface of the examined article; detecting, by the acoustic sensors, the reflected acoustic signals, where the reflected acoustic signals comprise a subset of the sent acoustic signals reflected off of the weld; and displaying, by the controller, an image of the weld corresponding to the reflected acoustic signals.

### BACKGROUND

Phased array ultrasonic testing is an investigation tool that uses transit time and the sound attenuation of echo pulses in materials to detect the presence of and the dimensions of defects that reflect the pulses. Phased array ultrasonic testing can examine defects such as voids in materials and lack of fusion in welds. Phased array ultrasonic testing uses a phased array probe having oscillator elements to send sound pulses that propagate into an examined article, and a portion of which are reflected back to receivers included in the phased array probe. Use of phased array probes can be complex with such complexity at times resulting in errors and/or spurious results.

Hence, there is a need in the art for advanced systems and methods for performing phased array ultrasonic testing.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Various embodiments provide methods for investigating a weld. The methods may include: automatically configuring, by a controller, a plurality of acoustic sensors arranged across a face of a phased array device to sense reflected acoustic signals; automatically configuring, by the controller, a plurality of acoustic sources arranged across the face of the phased array device to emit sent acoustic signals across an angular range from forty (40) degrees to seventy (70) degrees relative to the face; moving the phased array device across a surface of an examined article comprising a weld, where the face moves parallel to the surface of the examined article; detecting, by the acoustic sensors, the reflected acoustic signals, where the reflected acoustic signals comprise a subset of the sent acoustic signals reflected off of the weld; and displaying, by the controller, an image of the weld corresponding to the reflected acoustic signals.

Various other embodiments provide systems for investigating weld geometries. The systems may include: a phased array device and a controller. In some cases, the phased array device includes: a housing having a face; a sonic probe extending from the housing; a set of acoustic sources, where each of the acoustic sources in the set of acoustic sources is configured to emit an acoustic signal at a different time resulting in the set of acoustic sources generating acoustic signals across a first angular range from forty (40) degrees to seventy (70) degrees relative to the face; and a set of acoustic sensors, where each acoustic sensor in the set of acoustic sensors is configured to sense reflected acoustic signals at a different time resulting in the set of acoustic sensors sensing reflected acoustic signals limited to a second angular range from forty-six (46) degrees to seventy-six (76) degrees relative to the face. The controller may be communicably coupled to the phased array device and configured to receive acoustic data derived from the reflected acoustic signals. In other cases, the phased array device may include: a housing having a face, and a sonic probe extending from the housing; a number of acoustic elements coupled to the sonic probe and arranged along the face. The controller may be communicably coupled to the phased array device and configured to: automatically configure a first subset of the number of acoustic elements as acoustic sensors; and automatically configure a second subset of the number of acoustic elements as acoustic sources. Each of the acoustic sources is configured to emit an acoustic signal at a selected time resulting in the second subset of the number of acoustic elements emitting acoustic signals across an angular range from forty (40) degrees to seventy (70) degrees relative to the face.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1G show a phased array system including a controller configured to cause sonic pulses to be steered into an examined article examined across a forty to seventy-degree angular region with reflected signals gathered across a forty-six to seventy-six degree angular region in accordance with various embodiments.

FIGS. 2A-2B depict a sonic probe of a phased array device emitting sonic pulses that are steered into an examined article at defined angles in accordance with some embodiments.

FIG. 3 is a flow diagram showing a method in accordance with some embodiments for investigating complex weld geometries.

FIG. 4 shows an example of sonic pulses reflecting within an examined article.

FIG. 5 shows a computer system that may be used to implement one or more of the processor-based elements discussed herein.

### DETAILED DESCRIPTION

Various embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “cell” includes reference to one or more of such cells.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the elements shown in a presented flowchart may be omitted, repeated, and/or performed in a different order than the order shown. Accordingly, the scope disclosed herein should not be considered limited to the specific arrangement of steps shown in any given flowchart.

Although multiple dependent claims are not introduced, it would be apparent to one of ordinary skill that the subject matter of the dependent claims of one or more embodiments may be combined with other dependent claims.

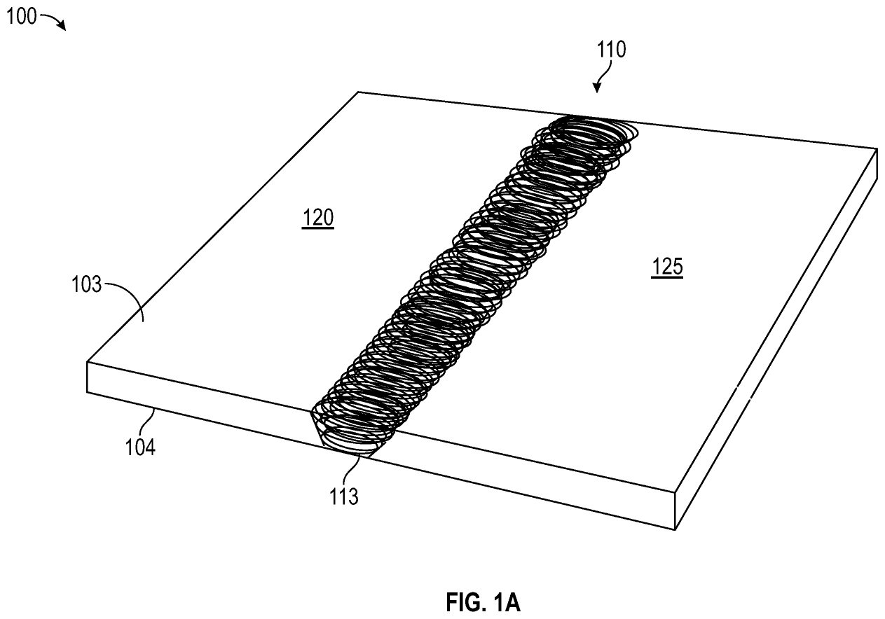

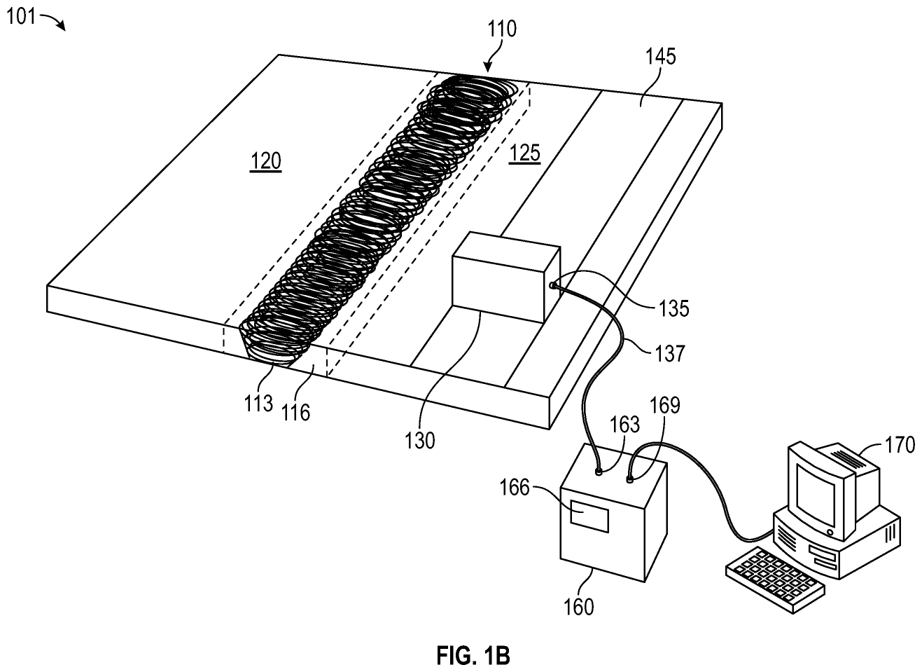

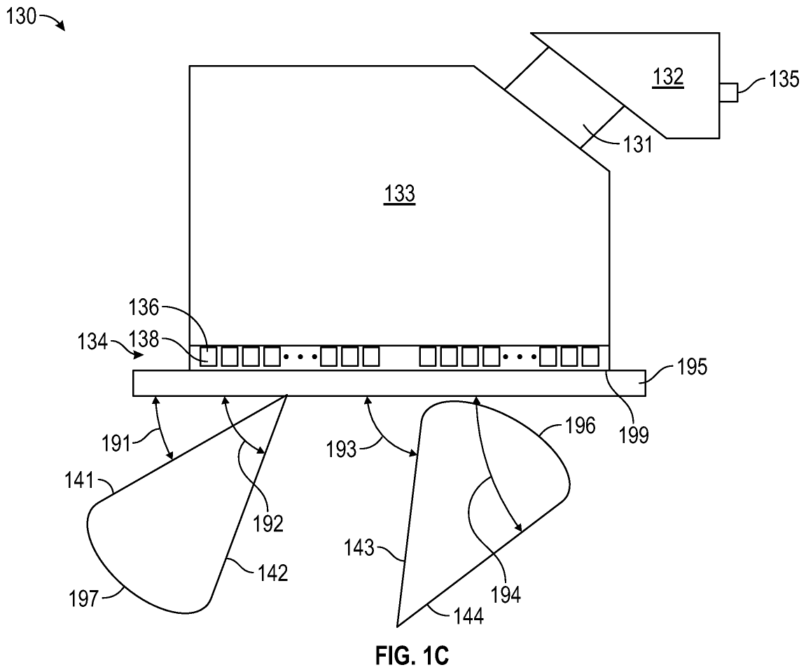

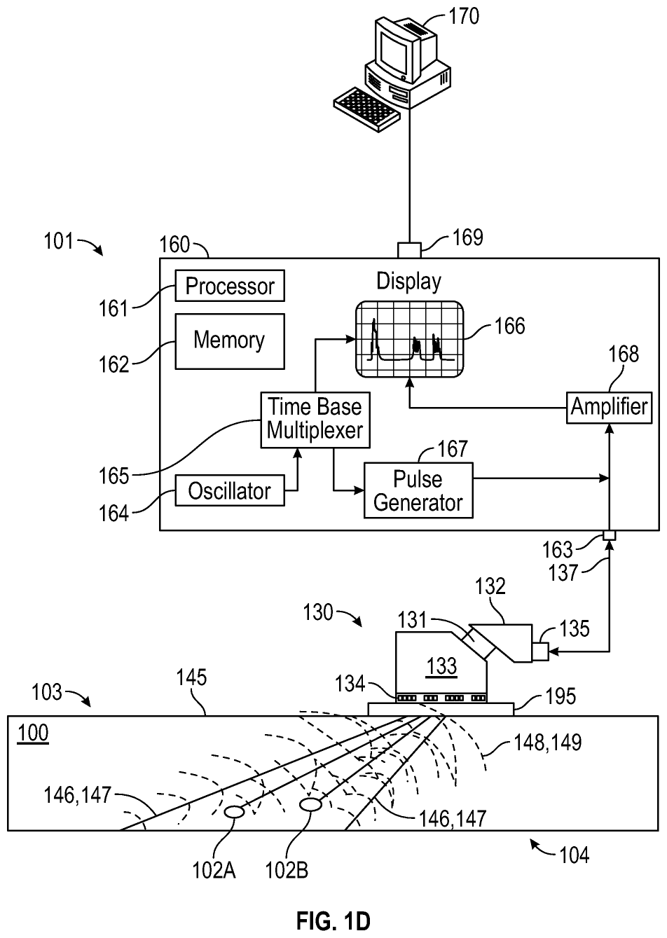

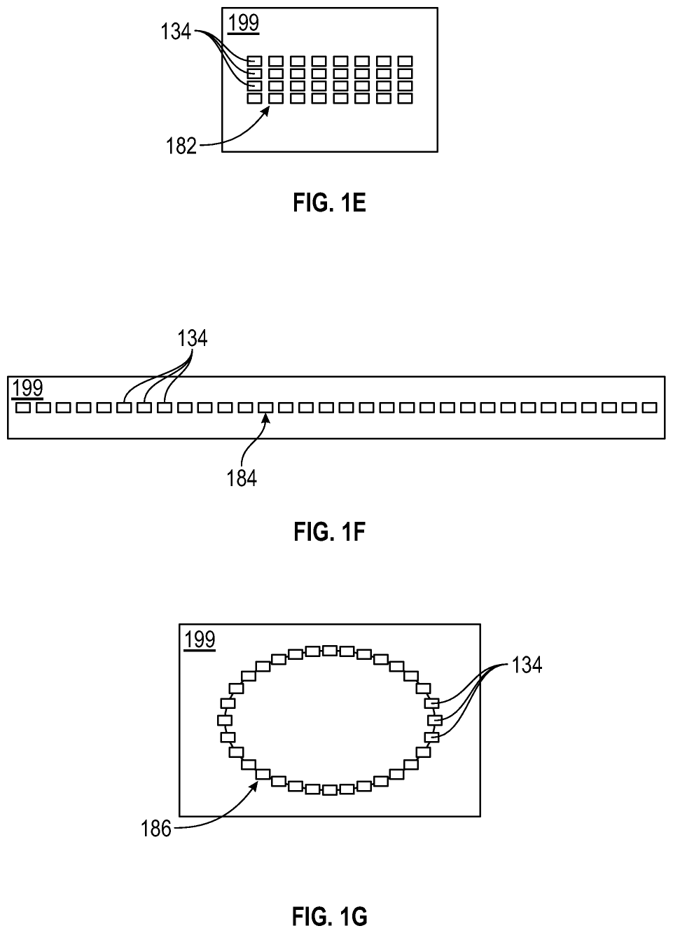

In the following description of FIGS. 1-5 any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It has been found that various errors and considerable time is wasted configuring phased array systems to investigate complex weld geometries. This time is wasted as a user attempts to determine which configuration provides a reasonable response when presented with investigating a complex weld geometries. Further, in many cases a user simply accepts a poor result from a sub-standard configuration resulting in improper measurements and results. This can result in failure of a weld that was not properly investigated.

It has been found that a set of default configurations automatically applied to a phased array device reduces the potential for error. These default configurations may be fixed. In some embodiments, a system for investigating weld geometries may include a phased array device including a housing having a face and a controller. The phased array device includes a sonic probe extending from the housing, a set of acoustic sources where each of the acoustic sources in the set of acoustic sources is configured to emit an acoustic signal at a different delay time relative to other acoustic sources resulting in the set of acoustic sources emitting acoustic signals across a first angular range from forty (40) degrees to seventy (70) degrees relative to the face, and a set of acoustic sensors where each acoustic sensor in the set of acoustic sensors is configured to sense reflected acoustic signals at a different delay time resulting in the set of acoustic sensors sensing reflected acoustic signals across a second angular range from forty-six (46) degrees to seventy-six (76) degrees relative to the face. The controller is communicably coupled to the phased array device and configured to receive acoustic data derived from the reflected acoustic signals.

Other embodiments provide systems investigating weld geometries that include a phased array device including a housing having a face, and a controller. The phased array device includes: a housing having a face, a sonic probe extending from the housing, and a number of acoustic elements coupled to the sonic probe and arranged along the face. The controller is communicably coupled to the phased array device and is configured to: automatically configure a first subset of the number of acoustic elements as acoustic sensors; and automatically configure a second subset of the number of acoustic elements as acoustic sources where each of the acoustic sources is configured to emit an acoustic signal at a selected time resulting in the second subset of the number of acoustic elements emitting acoustic signals across an angular range from forty (40) degrees to seventy (70) degrees relative to the face. In various cases, the number of acoustic elements is sixty-four (64), the first subset of the number of acoustic elements includes thirty-two (32) acoustic sensors, and the second subset of the number of acoustic elements includes thirty-two (32) acoustic sources. In various cases, each of the acoustic sensors is configured to emit an acoustic signal at a selected time resulting in the first subset of the number of acoustic elements sensing reflected acoustic signals across a second angular range from forty-six (46) degrees to seventy-six (76) degrees relative to the face. In various cases, the controller includes a processor and a computer readable medium. The computer readable medium is communicably coupled to the processor and has stored thereon instructions which, when executed by the processor, cause the controller to: automatically configure the first subset of the number of acoustic elements as the acoustic sensors; and automatically configure the second subset of the number of acoustic elements as the acoustic sources.

FIGS. 1A-1G show a phased array system 101 including a controller 160 configured to cause sonic pulses or acoustic signals to be generated and steered from a phased array device 130 into an examined article 100. For the purposes of this document, sonic pulses may be interchangeably used with acoustic signals, ultrasonic signals, or sound waves. In some embodiments, the sonic pulses may be steered such that they emanate from phased array device 130 across a forty (40) degree to seventy (70) degree angular region with reflected signals sensed across a forty-six (46) degree to seventy-six (76) degree angular region. Turning to FIG. 1A, examined article 100 is shown. In this particular example, examined article 100 includes two plates 120, 125 that have been joined by a weld 110. Plates 120, 125 may be made of any material that is fusible during a welding process to yield examined article 100 and/or capable of propagating acoustic waves. The material may include, but is not limited to, steel, aluminum, plastic, or brass. Based upon the disclosure provided herein, one of ordinary skill in the art will recognize a variety of materials and/or combinations of materials that may be used to form examined article 100 in relation to different embodiments.

Weld 110 has an upper surface area extending along an upper surface 103 of examined article 100 with a first width. Weld 110 may be any type of weld where material from plate 120 is fused with material from plate 125. Weld 110 extends from upper surface 103 toward a lower surface 104 of examined article with a width of weld 110 narrowing as it moves from upper surface 103 toward lower surface 104 resulting in a characteristic inverted triangular shape 113. A thickness of examined article is the distance between upper surface 103 and lower surface 104.

Although FIGS. 1A-1B show a butt joint, single v-groove fusion weld in region of interest 116, region of interest 116 may include any, all, or some part of the butt joint, single v-groove fusion weld. Furthermore, region of interest 116 may include any, all, or some part of any appropriate type of inspection region of interest, such as, without limitation, a fastener such as a bolt, screw, stud, or nut; a beam, a sheet, a plate, a bar, a rod; or round, rectangular, square, or hexagonal bar stock; a fillet weld, groove weld, slot weld, spot weld, seam weld, or plug weld. Further, although weld 110 is described as a fusion weld, other types of joining may be used in relation to different embodiments including, but not limited to, a bonded joint (using chemical bonding such as a glue, an adhesive, etc.), a brazed joint, a soldered joint, an extrusion welded joint, a hot gas welded joint, and a speed tip welded joint. Phased array system 101 may be used on an examined article that includes, but is not limited to, a fusion-bonded high-density polyethylene pond liner, a steel component chemically bonded to another steel component such as a hood liner to an automotive hood, or an aluminum panel adhesively bonded to an aluminum frame such as an external skin to an aircraft frame, and/or a welded pipe in the oil and gas industry.

Turning to FIG. 1B, phased array system 101 is shown in relation to examined article 100. As shown, a phased array device 130 is moved over upper surface 103 of examined article within proximity of a region of interest 116. As sonic pulses are directed into examined article 100 at angles between seventy (70) degrees relative to a face 199 and forty (40) degrees relative to face 199, phased array device 130 investigating region of interest 116 may be moved along a test surface 145 that is not directly over the region of interest.

Reflections of the sonic pulses generated by phased array device 130 are received by phased array device 130 at reception angles between seventy-six (76) degrees relative to face 199 and forty-six (46) degrees relative to face 199. Information about the sensed sonic pulses (i.e., reflected acoustic signals) is provided to a controller 160 via a wiring harness 137. Wiring harness 137 may include any type of power and communication components that conduct electricity and/or signals. Further, wiring harness 137 may include electrical and/or signal conductors made of electrical wires such as copper and aluminum, and/or wiring harness 137 may have signal conductors such as optical fiber. Wiring harness 137 connects to phased array device 130 at a connector 135, and to controller 160 at a connector 169. Controller 160 includes, among other things, a display that displays the received information. The displayed information will show any identified discontinuities to an operator of phased array device 130. Such discontinuities may be defined as any irregularity in the reflected sonic pulses (i.e., reflected acoustic signals). As some examples, edges of weld 110 may be shown as discontinuities on display 166 and other defects in either plates 120, 125 or weld 110 may be shown as discontinuities on display 166. As used herein, the term “discontinuity” is used in its broadest sense to mean any irregularity in a reflected sonic wave form. Based upon the disclosure provided herein, one of ordinary skill in the art will recognize a variety discontinuities that may be detected using phased array device in accordance with different embodiments.

Upon indication of a discontinuity, an operator of phased array device 130 may be notified of a need to evaluate the indicated discontinuity. This notification may be a depiction of the received information on display 166. Alternatively, or in addition, other types of notifications may be done including, but not limited to, an audible notification. The operator could then review the discontinuity to determine if it represents a defect or flaw in examined article 100. The diagnosis may include a determination of a location of the defect and an evaluation of whether the defect is substantial enough to affect the purpose of examined article 100. As used herein, the term “defect” is used in its broadest sense to mean any diagnosed flaw that corresponds to an identified discontinuity. Such defects include, but are not limited to, material separations, inclusions, lack of side wall fusion (i.e., a weld material does not fuse with the parent plate), lack of inter-run fusion (i.e., a weld material does not adequately penetrate the previous weld bead), fractures, cracks, pores, blisters, blowholes, voids, duplications, segregations, inclusions, slag lines and double slag lines, inhomogeneities, and wall thickness variations. Based upon the disclosure provided herein, one of ordinary skill in the art will recognize a variety defects that may be diagnosed using data from phased array devices in accordance with different embodiments.

In addition to being displayed via display 166, controller 160 does some processing of the information and provides resulting processed information to a computer 170 via a connector 169. Computer 170 may be any type of computer known in the art. Computer 170 may be used to apply one or more algorithms to the received processed information.

Turning to FIG. 1C, a shoe 133 of phased array device 130 houses a sonic probe 131 connected to a group of acoustic elements 134 arranged across face 199 of shoe 133 such that they can be maintained in close proximity of a couplant 195. Face 199 may be substantially planar and is placed in close proximity to upper surface 103 of examined article 100.

Couplant 195 may be any material applied between phased array device 130 and examined article 100. Quality couplant materials are configured to assure as much as possible of the energy from sonic waves transmitted from phased array device 130 is introduced into examined article 100, and that as much as possible of the energy from sonic waves reflected within examined article 100 are returned to phased array device 130. Couplant 195 may be, but is not limited to, water or a gel, paste, oil, grease, or adhesive. Based upon the disclosure provided herein, one of ordinary skill in the art will recognize a variety of couplants that may be used in relation to different embodiments.

Sonic probe 131 is mounted in and extends from shoe 133 and a communication interface 132 is coupled to sonic probe 131 as shown. Communication connector 135 is incorporated in communication interface 132. Sonic probe 131 includes acoustic elements 134 that are configured to both transmit acoustic signals and receive reflected acoustic signals. In some embodiments, each of acoustic elements 134 includes one or more piezoelectric oscillators 136 and/or one or more acoustic sensors 138. In various embodiments, each of acoustic elements 134 includes one piezoelectric crystal that is pulsed to generate acoustic signals and one piezoelectric crystal configured to sense reflected sonic signals. When an electric pulse is applied to the piezoelectric crystal, the piezoelectric crystal vibrates at a very high (ultrasonic) frequency such as between 1 MHz (megahertz) and 15 MHz. Frequencies used for ultrasonic weld inspection may be between 2 MHz and 5 Mhz. The lower frequencies may be used for the examination of coarse-grained material or on rough surfaces. Higher frequencies may be used for the detection of fine defects such as cracks or lack of fusion. These sonic pulses or acoustic signals propagate through couplant 195 at a selected angle relative to face 199 of examined article 100 where phased array device 130 is moved across examined article 100. Each of acoustic elements 134 may be configured to send and receive sonic signals independent of other acoustic elements at the same time or at different times.

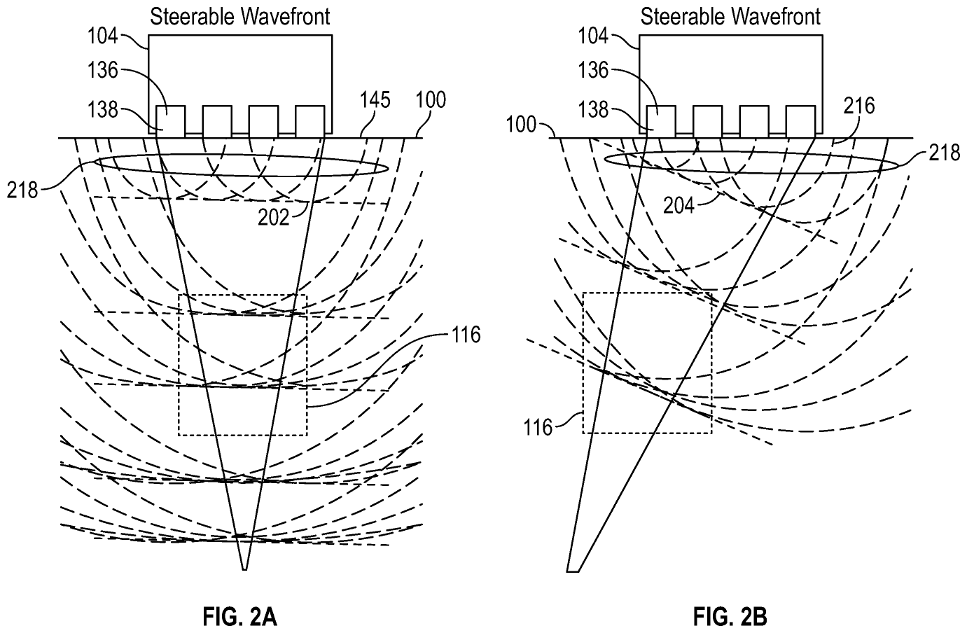

Acoustic elements 134 may be arranged as a line array, as a two-dimensional matrix, as a ring array, or in a complex arbitrary shape. Based upon the disclosure provided herein, one of ordinary skill in the art will recognize a variety of arrangements of acoustic elements 134 that may be implemented in relation to different embodiments. Some embodiments include a number of acoustic elements 134 that are divided equally between piezoelectric oscillators 136 and acoustic sensors 138. In one particular embodiment, a single sonic probe with sixty-four (64) acoustic elements is configured to include thirty-two (32) piezoelectric oscillators 136 and thirty-two (32) acoustic sensors. It has been determined that such a sonic probe including sixty-four (64) acoustic elements is adequate for investigating welds in an examined article up to sixteen (16) millimeters thick. Two separate sonic probes each including thirty-two (32) acoustic elements and laterally offset from each other may be used for examined articles with a thickness of greater than sixteen (16) millimeters. In such a case, the thirty-two (32) acoustic elements in one of the sonic probes are configured as piezoelectric oscillators and the thirty-two (32) acoustic elements in the other of the sonic probes are configured as acoustic sensors. The distance of the lateral offset between the sonic probes is selected based upon the thickness of the examined article. The selected angles for each of acoustic elements 134 may be different allowing for steering groups of sonic pulses as more fully discussed below in relation to FIGS. 2A-2B. In some embodiments, the range of selected angles 197 extends from an outer limit of 142 at an angle 192 of seventy (70) degrees relative to face 199 and an outer limit 141 at an angle 191 of forty (40) degrees relative to face 199. The angular range from forty (40) degrees to seventy (70) degrees has been found to result in a high degree of internal reflection, and therefore yields reasonable images of welds with standard weld bevel or taper of about three (3) degrees (represented in triangular shape 113).

Acoustic sensors 138 in each of acoustic elements 134 are arranged to receive sonic energy reflecting from within examined article 100 across a range of angles relative to face 199 of examined article 100 where phased array device 130 is moved across examined article 100. In some embodiments, the range of angles 196 extends from an outer limit of 143 at an angle 194 of seventy-six (76) degrees relative to face 199 and an outer limit 144 at an angle 193 of forty-six (46) degrees relative to face 199. It has been found that the angular range from forty-six (46) degrees to seventy-six (76) degrees has been found to yield reasonable images of welds with standard weld tapers. Such an angular range ensures reasonable reception of the reflected acoustic signals. An angle difference between acoustic signals emitted from piezoelectric oscillators 136 and acoustic sensors 138 is double the angle of the bevel or taper of weld being investigated. Thus, where this bevel or taper is expected to be about three (3) degrees, the expected reflected acoustic signals should therefore be found between forty-six (46) (i.e., 40+3*2) degrees to seventy-six (76) degrees (i.e., 70+3*2) relative to face 199.

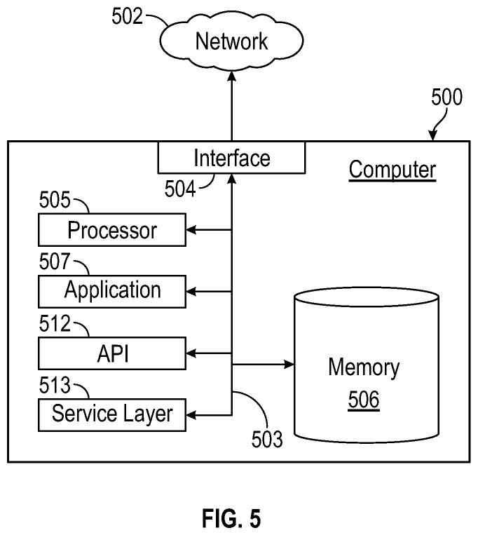

Turning to FIG. 1D, a schematic view of phased array system 101 is shown in accordance with some embodiments. As shown, controller 160 includes a processor 161. Processor 161 may be any electronic circuit known in the art that is capable of executing instructions causing performance of the actions of controller 160. A machine executable form of the instructions may be maintained in a memory 162, and may be available as either software or firmware that is uploadable to controller 160 using computer 170. In some embodiments, controller 160 may be a ruggedized computer system with functionality to withstand vibrations, extreme temperatures, wet conditions, and/or dusty conditions, for example, around a manufacturing environment, a field location of a pipeline installation, or around an onshore or offshore drilling rig. In some embodiments, controller 160 may be implemented in a computer system similar to that described below in relation to FIG. 5. Similarly, computer 170 may be implemented as the computer system described below in relation to FIG. 5.

Processor 161 causes an oscillator control module 164 that directs a time-based multiplexer 165 to cause a pulse generator 167 to pulse respective ones of piezoelectric oscillators 136 to yield desired sonic wave output. Pulse generator 167 generates a series of electrical pulses directed to respective piezoelectric oscillators 136 in accordance with a command received from time-based multiplexer 165. The command may indicate a frequency and timing of the pulses. The pulses are provided to one or more of the piezoelectric oscillators 136 of phased array device which in-turn cause a crystal in the respective piezoelectric oscillator 136 to vibrate at a defined frequency. At the same time, reflected sonic pulses are being transferred from phased array device 130 via wiring harness 137. This information (i.e., the reflected sonic pulses) are amplified by an amplifier 168, and the amplified output is correlated to the original pulses to generate a graphic for display 166.

In operation, processor 161 executes instructions from memory 162 to control operation of controller 160. As an example, in some embodiments processor 161 executes instructions to configure phased array device 130 to generate sonic pulses in a pattern between forty (40) degrees and seventy (70) degrees, and to sense reflected sonic pulses across a region of forty-six (46) degrees to seventy-six (76) degrees. Processor 161 additionally causes oscillator control module 164 to generate pulses at a defined frequency by piezoelectric oscillators 136. Processor 161 executes instructions for correlating reflected sonic pulses that have been amplified with sonic pulses from which the reflections derive. This correlated information is used to generate a graphic for display including any discontinuities. Processor 161 executes instructions that notify an operator of any discontinuities.

Phased array device 130 is moved across upper surface 103 in the area of test surface 145. Sonic probe 131 of phased array device 130 receives commands or pulses from controller 160 at communication interface 132, and in turn causes piezoelectric oscillators 136 in acoustic elements 134 to emit sonic pulses 146, 147 through couplant 195 and into examined article 100. Sonic pulses 146, 148 are directed over a region of inspection which in some embodiments is between seventy (70) degrees relative to face 199 and forty (40) degrees relative to face 199. Sonic pulses 146, 147 travel in a predictable path as a beam of a sonic pulses group until each sonic pulse encounters a discontinuity such as a defect 102A, a defect 102B, lower surface 104 (i.e., a backwall of examined article 100), and/or ends of examined article 100.

Some, most, or all of the acoustic signal hitting a defect or other obstruction (e.g., portions of examined article 100) is reflected. Depending on the angle at which the acoustic beam strikes the defect or other obstruction, some or all of the acoustic beam of sonic pulses 146, 148 will be reflected back to acoustic elements 134. The reflection from sonic pulses 146, 148 vibrate the piezoelectric crystal of acoustic sensors 138 from which a corresponding electrical signal is generated. This electrical signal is information that is transmitted from phased array device 130 to controller 160 via wiring harness 137. In some embodiments, only reflections received across a forty-six (46) degree to seventy-six (76) degree angular region measured from upper surface 103.

FIG. 1E shows acoustic elements 134 arranged along face 199 as a two-dimensional array 182. FIG. 1F shows acoustic elements 134 arranged along face 199 as a line array 184. FIG. 1G shows acoustic elements 134 arranged along face 199 as a ring array 186.

FIGS. 2A-2B show sonic probe 104 associated with phased array device 130 emitting sonic pulses 216 as a sonic pulses group 218 that are steered into examined article 100 at defined angles in accordance with some embodiments. In some embodiments, each of acoustic elements 134 can be individually controlled. By altering the timing and amplitude of the electrical signals sent to a given acoustic element 134 configured as a piezoelectric oscillator 136, the sonic pulses (i.e., ultrasonic waves) can be focused, steered, and scanned electronically. Said another way, by changing the progressive time delay the beam (i.e., ultrasonic waves) can be steered electronically. By controlling the phase array ultrasonic testing relationship between the elements in the array, constructive interference can be achieved, enhancing the amplitude of the ultrasonic waves at a specific focal point. Thus, by programming several of piezoelectric oscillators 136 to operate together, virtual probes can be created. Virtual probes then behave like a single oscillator with the corresponding properties of sound field size, sound direction, and focusing. By electronically activating or controlling (pulse shifting) these individual piezoelectric oscillators 136, steerable wavefronts 202, 204 can be generated by shifting sonic pulses from respective piezoelectric oscillators 136 desired steerable wavefronts 202, 204. The generated steerable wavefronts 202, 204 propagate through the examined article 100. In this manner, the region of interest 116 may be examined using a respective steerable wavefront 202, 204 transmitted from sonic probe 131 at test surface 145 without requiring sonic probe 131 to be directly over the region of interest 116.

Turning specifically to FIG. 2A, steerable wavefront 202 is set to cause sonic pulses group 218 to traverse examined article 100 at an angle of approximately ninety (90) degrees or perpendicular scanning. Turning to FIG. 2B, a steerable wavefront 204 is set to cause sonic pulses group 218 to traverse examined article 100 at an angle less than ninety (90) degrees (i.e., perpendicular scanning).

Phased array device 130 may be manually moved near region of interest 116 to investigate the integrity of weld 110. As phased array device 130 is moved relative to region of interest 116, reflections of sonic pulses group 218 are received by phased array device 130. Such reflections are reviewed to identify any discontinuities within region of interest 116. Such discontinuities may be defined as any irregularity suspected of being a flaw such as, for example, defects 102A, 102B in examined article 100.

Upon indication of a discontinuity, an operator or phased array device may notified of a need to evaluate the indicated discontinuity and diagnose any potential defect in examined article 100. The diagnosis may include a determination of a location of the defect and an evaluation of whether the defect is substantial enough to affect the purpose of examined article 100. Such defects include, but are not limited to, material separations, inclusions, lack of side wall fusion (i.e., a weld material does not fuse with the parent plate), lack of inter-run fusion (i.e., a weld material does not adequately penetrate the previous weld bead), fractures, cracks, pores, blisters, blowholes, voids, duplications, segregations, inclusions, slag lines and double slag lines, inhomogeneities, and wall thickness variations. Based upon the disclosure provided herein, one of ordinary skill in the art will recognize a variety defects that may be diagnosed using data from phased array devices in accordance with different embodiments.

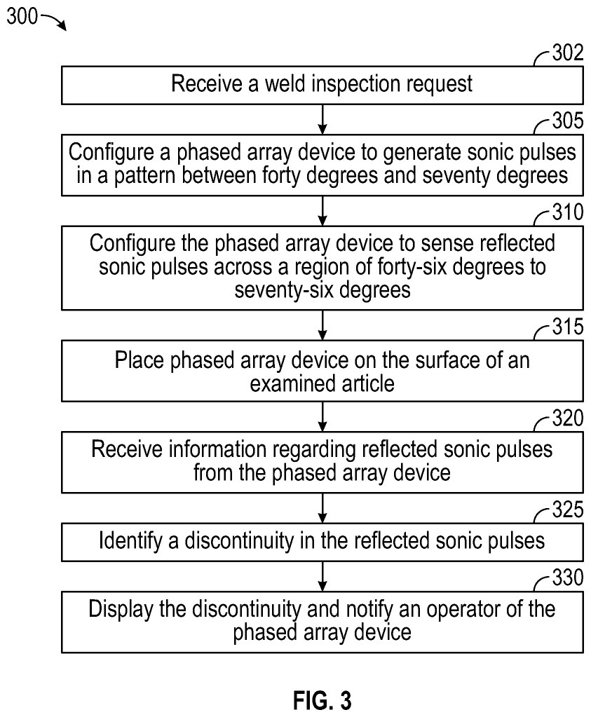

Turning to FIG. 3, a flow diagram 300 shows a method in accordance with some embodiments for investigating complex weld geometries. Following flow diagram 300, a weld inspection request is received (block 302). In some embodiments where a phased array device is always used to inspect welds, the weld inspection request is automatically considered as being received. In other embodiments, where a phased array device is used for multiple purposes, such a weld inspection request may be received when, for example, a user makes a weld inspection selection via a user interface of either a controller or computer communicably coupled to the phased array device. Based upon this weld inspection request, the phased array device is automatically configured as follows.

The phased array device is configured to generate sonic pulses in a pattern between forty (40) degrees and seventy (70) degrees relative to a surface or face of the phased array device (block 305). In some embodiments, a focal law calculator application is executed by a processor on a controller or a computer that is communicably coupled to a phased array device. In such an embodiment, the focal law calculator application automatically calculates configuration parameters for each acoustic elements configured as piezoelectric oscillators to achieve the desired angular range of forty (40) degrees and seventy (70) degrees. Such configuration parameters include, but are not limited to, delay times between activating or firing a given acoustic element relative to other acoustic elements. Firing or activating the respective piezoelectric oscillators in accordance with the delay times results in wave fronts from each piezoelectric oscillator combining constructively and/or destructively to create one main wave front which will travel (transmit) through an examined article.

The phased array device is configured to sense reflected sonic pulses from the generated pulses across a forty-six (46) degree to seventy-six (76) degree angular region (block 310). In some embodiments, the aforementioned focal law calculator application is executed by the processor on the controller or computer to automatically calculate configuration parameters of respective acoustic elements configured as acoustic sensors. The configuration parameters may include, but are not limited to, delay times from firing a given one of the piezoelectric oscillators for a reflected acoustic signal to present at a given one of the acoustic sensors at a desired angle. Enabling each of the respective acoustic sensors at the calculated delay time results in an “angle gate” or limited angular range over which reflected acoustic signals are sensed.

The configured phased array device is placed on a surface of an examined article (block 315). As the sonic pulses are generated in a pattern between forty (40) degrees and seventy (70) degrees relative to a surface of the phased array device, the location of the phased array device is not required to be placed directly over a region of interest. Rather, the phased array device may be placed away from the region of interest. In such a configuration, the reflected sonic pulses bounce off of discontinuities in the examined article such as, but not limited to, defects, surfaces of the examined article, and/or welds formed in the examined article. Using examined article 100 as an example, the reflected sonic pulses bounce off of discontinuities in the examined article including defect 102A, a defect 102B, lower surface 104 (i.e., a backwall of examined article 100), and/or ends of examined article 100.

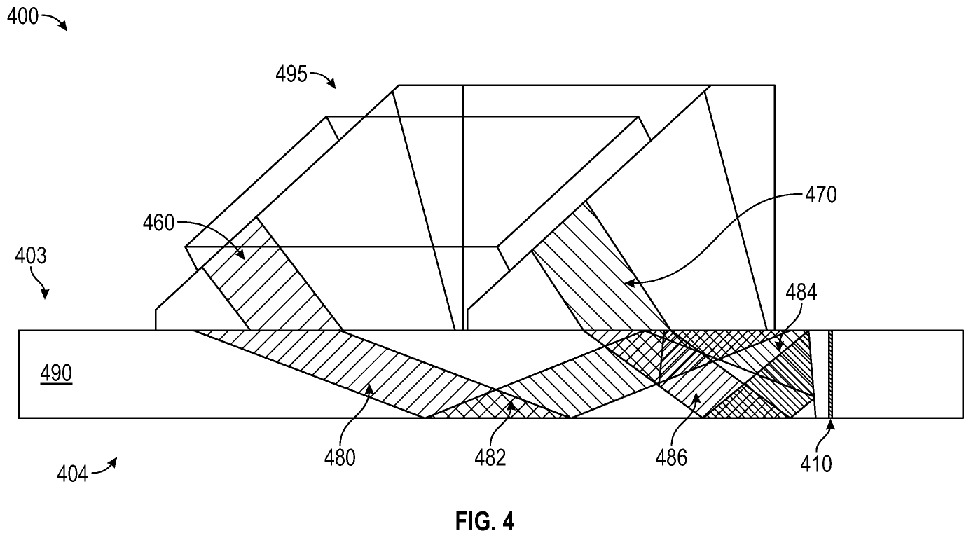

Turning to FIG. 4, an example of sonic pulses 460 injected into an examined article 490 with reflected sonic pulses 470 returning to a phased array device 495 is shown in accordance with some embodiments. As shown, sonic pulses 460 are injected into examined article 490 through an upper surface 403 causing them to refract resulting in refracted pulses 480. Refracted pulses 480 continue until a lower surface 404 causing them to reflect resulting in reflected pulses 482 then off of upper surface 403 resulting in reflected pulses 484. Reflected pulses 484 continue until they reflect off of a weld 410 and then lower surface 404 to yield reflected pulses 486. At least a portion of reflected pulses 486 refract through upper surface 403 and continue on to be received as reflected pulses 470 by phased array device 495.

Returning to FIG. 3., as the reflected sonic pulses return to the phased array device, information about the sensed, reflected sonic pulses is received (block 320). This information may be processed using any approach known in the art for processing information corresponding to sensed, reflected sonic pulses. The information about the sensed, reflected sonic pulses is used to identify any discontinuities in the received sonic pulses (block 325). Identification of any discontinuities may be done using any process known in the art. In some embodiments, any identified discontinuities may cause an alert to be generated to an operator of the phased array device. In some embodiments, the alert may be an audible alert. The discontinuities are displayed to an operator of the phased array device via a display (block 330). Any approach known in the art for displaying discontinuities in the received sonic pulses may be used.

Turning to FIG. 5, a computer system 500 is shown that may be used to implement one or more of the processor-based systems discussed herein. For example, controller 160 and/or computer 170 may be implemented similar to computer system 500. Computer system 500 is intended to encompass any computing device such as a high-performance computing device, a server, desktop computer, laptop/notebook computer, wireless data port, smart phone, personal data assistant, tablet computing device, processing functionality of a controller, one or more processors within these devices, or any other suitable processing device, including both physical or virtual instances (or both) of the computing device. Additionally, computer system 500 may include a computer that includes an input device, such as a keypad, keyboard, touch screen, or other device that can accept user information, and an output device that conveys information associated with the operation of computer system 500, including digital data, visual, or audio information (or a combination of information), or a graphical user interface. In some embodiments, computer system 500 may be used to implement the controller related functionality discussed above in relation to FIG. 1D, automated portions of the algorithm in FIG. 3, and/or computer 170. Based upon the disclosure provided herein, one of ordinary skill in the art will recognize other computer systems that may be used in implementations within embodiments discussed herein.

Computer system 500 can serve in a role as a client, network component, a server, a database or other persistency, or any other component (or a combination of roles) of a computer system for performing the subject matter described in the instant disclosure. Computer system 500 is communicably coupled with a network 502 or cloud. In some implementations, one or more components of computer system 500 may be configured to operate within environments, including cloud-computing-based, local, global, or other environment (or a combination of environments).

At a high level, computer system 500 is an electronic computing device operable to receive, transmit, process, store, or manage data and information associated with the described subject matter. According to some implementations, computer system 500 may also include or be communicably coupled with an application server, e-mail server, web server, caching server, streaming data server, business intelligence server, or other server or a combination of servers.

Computer system 500 can receive requests over network 502 or cloud from a client application (for example, executing on another computer system 500) and responding to the received requests by processing the said requests in an appropriate software application. In addition, requests may also be sent to computer system 500 from internal users (for example, from a command console or by other appropriate access method), external or third-parties, other automated applications, as well as any other appropriate entities, individuals, systems, or computers.

Each of the components of computer system 500 can communicate using a system bus 504. In some implementations, any or all of the components of computer system 500, both hardware or software (or a combination of hardware and software), may interface with each other or an interface 504 (or a combination of both) over system bus 503 using an application programming interface 512 (API 512) or a service layer 513 (or a combination of the API 512 and service layer 513). API 512 may include specifications for routines, data structures, and object classes. API 512 may be either computer-language independent or dependent and refer to a complete interface, a single function, or even a set of APIs. Service layer 513 provides software services to computer system 500 or other components (whether or not illustrated) that are communicably coupled to computer system 500. The functionality of computer system 500 may be accessible for all service consumers using this service layer. Software services, such as those provided by service layer 513, provide reusable, defined business functionalities through a defined interface. For example, the interface may be software written in JAVA, C++, or other suitable language providing data in extensible markup language (XML) format or other suitable format. While illustrated as an integrated component of computer system 500, alternative implementations may illustrate API 512 or service layer 513 as stand-alone components in relation to other components of computer system 500 or other components (whether or not illustrated) that are communicably coupled to computer system 500. Moreover, any or all parts of API 512 or service layer 513 may be implemented as child or sub-modules of another software module, enterprise application, or hardware module without departing from the scope of this disclosure.

Computer system 500 includes interface 504. Although illustrated as a single one of interface 504 in FIG. 5, two or more of interface 504 may be used according to particular needs, desires, or particular implementations of computer system 500. Interface 504 is used by computer system 500 for communicating with other systems in a distributed environment, some or all of which are connected to the network 502. Generally, the interface 504 includes logic encoded in software or hardware (or a combination of software and hardware) and operable to communicate with the network 502 or cloud. More specifically, interface 504 may include software supporting one or more communication protocols associated with communications such that the network 502 or interface's hardware is operable to communicate physical signals within and outside of computer system 500.

Computer system 500 includes at least one of a computer processor 505. Although illustrated as a single one of computer processor 505 in FIG. 5, two or more processors may be used according to particular needs, desires, or particular implementations of computer system 500. Computer processor 505 executes instructions and manipulates data to perform the operations of computer system 500 and any algorithms, methods, functions, processes, flows, and procedures as described in the instant disclosure.

Computer system 500 also includes a memory 506 that holds data for computer system 500 or other components (or a combination of both) that can be connected to the network 502. For example, memory 506 may be a database storing data consistent with this disclosure. Although illustrated as a single one of memory 506 in FIG. 5, two or more memories may be used according to particular needs, desires, or particular implementations of computer system 500 and the described functionality. Although memory 506 is illustrated as an integral component of computer system 500, in alternative implementations, memory 506 may be external to computer system 500.

An application 507 is an algorithmic software engine providing functionality according to particular needs, desires, or particular implementations of computer system 500, particularly with respect to functionality described in this disclosure. For example, application 507 can serve as one or more components, modules, applications, etc. Further, although illustrated as a single one of application 507, the application 507 may be implemented as a multiple quantity of application 507 on computer system 500. In addition, although illustrated as integral to computer system 500, in alternative implementations, the application 507 may be external to computer system 500.

There may be any number of computer system 500 associated with, or external to, a computer system containing computer system 500, wherein each computer system 500 communicates over network 502. Further, the term “client,” “user,” and other appropriate terminology may be used interchangeably as appropriate without departing from the scope of this disclosure. Moreover, this disclosure contemplates that many users may use one of computer system 500, or that one user may use multiple computers of computer system 500.

In some embodiments, computer system 500 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), artificial intelligence as a service (AIaaS), serverless computing, and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for investigating weld geometries, the system comprising:
a phased array device comprising:
a housing having a face;
a sonic probe extending from the housing;
a set of acoustic sources, wherein each of the acoustic sources in the set of acoustic sources is configured to emit an acoustic signal at a different time resulting in the set of acoustic sources generating acoustic signals across a first angular range from forty (40) degrees to seventy (70) degrees relative to the face; and
a set of acoustic sensors, wherein each acoustic sensor in the set of acoustic sensors is configured to sense reflected acoustic signals at a different time resulting in the set of acoustic sensors sensing reflected acoustic signals limited to a second angular range from forty-six (46) degrees to seventy-six (76) degrees relative to the face; and
a controller communicably coupled to the phased array device and configured to receive acoustic data derived from the reflected acoustic signals.

2. The system of claim 1, wherein the set of acoustic sources comprises thirty-two (32) acoustic sources, and wherein the set of acoustic sensors comprises thirty-two (32) piezoelectric oscillators.

3. A system for investigating weld geometries, the system comprising:
a phased array device comprising:
a housing having a face;
a sonic probe extending from the housing;
a number of acoustic elements coupled to the sonic probe and arranged along the face; and
a controller communicably coupled to the phased array device, the controller configured to:
automatically configure a first subset of the number of acoustic elements as acoustic sensors; and
automatically configure a second subset of the number of acoustic elements as acoustic sources, and wherein each of the acoustic sources is configured to emit an acoustic signal at a selected time resulting in the second subset of the number of acoustic elements emitting acoustic signals across an angular range from forty (40) degrees to seventy (70) degrees relative to the face.

4. The system of claim 3, wherein the number of acoustic elements are arranged in an array type selected from a group consisting of: a line array, a two-dimensional array, and a ring array.

5. The system of claim 3, wherein the selected time of least one of the acoustic sources is activated at time resulting in an acoustic signal emanating at forty (40) degrees relative to the face.

6. The system of claim 3, wherein the selected time of least one of the acoustic sources is activated at time resulting in an acoustic signal emanating at seventy (70) degrees relative to the face.

7. The system of claim 3, wherein the number is sixty-four (64).

8. The system of claim 7, wherein the first subset of the number of acoustic elements includes thirty-two (32) acoustic sensors, and wherein the second subset of the number of acoustic elements includes thirty-two (32) acoustic sources.

9. The system of claim 3, wherein the acoustic sources are piezoelectric acoustic oscillators.

10. The system of claim 3, wherein the angular range is a first angular range, and wherein each of the acoustic sensors is configured to receive a reflected acoustic signal at a selected time resulting in the first subset of the number of acoustic elements sensing the reflected acoustic signals across a second angular range from forty-six (46) degrees to seventy-six (76) degrees relative to the face.

11. The system of claim 3, wherein the controller comprises:
a processor; and
a computer readable medium communicably coupled to the processor and having stored thereon instructions which, when executed by the processor, cause the controller to:
receive a weld inspection request;
based at least in part on the weld inspection request:
automatically configure the first subset of the number of acoustic elements as the acoustic sensors; and
automatically configure the second subset of the number of acoustic elements as the acoustic sources.

12. A method for investigating a weld, the method comprising:
automatically configuring, by a controller, a plurality of acoustic sensors arranged across a face of a phased array device to sense reflected acoustic signals;
automatically configuring, by the controller, a plurality of acoustic sources arranged across the face of the phased array device to emit sent acoustic signals across an angular range from forty (40) degrees to seventy (70) degrees relative to the face;
moving the phased array device across a surface of an examined article comprising a weld, wherein the face moves parallel to the surface of the examined article;
detecting, by the acoustic sensors, the reflected acoustic signals, wherein the reflected acoustic signals comprise a subset of the sent acoustic signals reflected off of the weld; and
displaying, by the controller, an image of the weld corresponding to the reflected acoustic signals.

13. The method of claim 12, wherein the face is a planar surfaced of a housing of the phased array device, and wherein a combination of the plurality of acoustic sensors and the plurality of acoustic sources are disposed across the face in an array type selected from a group consisting of: a line array, a two-dimensional array, and a ring array.

14. The method of claim 12, wherein each of the plurality of sonic sources is configured to emit one of the sent acoustic signals at a time delay that is different from another time delay of any other of the plurality of sonic sources.

15. The method of claim 12, wherein at least one of the plurality of sonic sources is configured to emit one of the sent acoustic signals at a time resulting in an acoustic signal emanating at forty (40) degrees relative to the face.

16. The method of claim 12, wherein at least one of the plurality of sonic sources is configured to emit one of the sent acoustic signals at a time resulting in an acoustic signal emanating at seventy (70) degrees relative to the face.

17. The method of claim 12, wherein the plurality of acoustic sources includes a defined number of acoustic sources, and wherein the plurality of acoustic sensors includes the defined number of acoustic sensors.

18. The method of claim 17, wherein the defined number is thirty-two (32).

19. The method of claim 12, wherein the acoustic sources are piezoelectric acoustic oscillators.

20. The method of claim 12, wherein the angular range is a first angular range, and the method further comprises:
automatically configuring, by the controller, the plurality of acoustic sources to sense only the reflected acoustic signals across a second angular range from forty-six (46) degrees to seventy-six (76) degrees relative to the face.
